(19) United States
(12) Patent Application Publication
(10) Pub. No.: US 2026/0252742 A1
(43) Pub. Date: Aug. 27, 2026

(54) SYSTEM AND METHOD FOR A MULTIFUNCTIONAL PHYSICAL CREDENTIAL

(71) Applicant: ASSA ABLOY AB, Stockholm (SE)

(72) Inventors: Rameshbabu R. Songukrishnasamy, Austin, TX (US); Robert Kjell Rowe, Poulsbo, WA (US)

(21) Appl. No.: 19/059,676

(22) Filed: Feb. 21, 2025

(51) Int. Cl. G06F 21/84; G06F 21/31; G10L 15/22; H04W 4/70

(52) U.S. Cl. CPC G06F 21/84; G06F 21/31; G10L 15/22; H04W 4/70

(57) ABSTRACT

A multifunctional badge includes a dynamic display, a natural language interface, and a badge controller operatively coupled to the dynamic display and natural language interface. The badge controller is configured to change the information displayed on the dynamic display and receive natural language input via the natural language interface and output natural language information via natural language interface.

### TECHNICAL FIELD

Embodiments illustrated and described herein generally relate to physical credentials that identify the wearer as having rights to physical and logical access to resources.

### BACKGROUND

Credential information, or credentials, provides proof of the person’s identity. Credentials for physical and logical access can be broadly classified as either digital credentials or physical credentials. Generally, digital credentials that reside on a personal device such as a mobile phone are seen to be both more secure and convenient than a physical credential. However, there are many instances, such as in many enterprise and government facilities, which require physical credentials in the form of a badge that is worn and visible to others so that they may be able to see that the wearer is authorized to be in that area. However, the functionality and generality of such credentials is limited. Moreover, in many cases employees and others in such facilities may also have to carry a mobile phone to conduct a variety of other business functions such as retrieving various passwords, reading and sending email and text messages, looking up and setting meetings and other events on a calendar. Mobile phone manufacturers are increasingly imposing their control on the functionality of mobile phones, which may raise privacy and security concerns for credential data. With the increasing control imposed by the mobile manufactures, there is a need for an alternative ecosystem outside of mobile phones that would enable growth of new use cases free from the data privacy concerns of Mobile OEMs.

### BRIEF DESCRIPTION OF THE DRAWINGS

FIG. 1 is an illustration of an example of a multifunction badge (MFB).

FIG. 2 is a block diagram of portions of an example of an MFB.

FIG. 3 is another illustration of an example of an MFB.

FIG. 4 is another block diagram of portions of an example of an MFB.

FIG. 5 is an illustration of an example of a Physical Access Control System structure.

FIG. 6 is an illustration of an example of an ultra-wide band (UWB) capable MFB and another UWB capable device.

FIG. 7 is a flow diagram of an example of a method of operating an MFB.

FIG. 8 is an illustration of a system for provisioning information to MFBs.

FIG. 9 is a block diagram schematic of various example components for supporting the device architectures described and illustrated herein.

### DETAILED DESCRIPTION

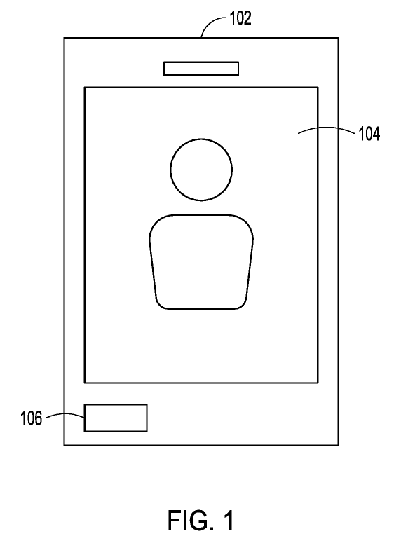

FIG. 1 is an illustration of an example of a multifunctional physical credential. The multifunctional physical credential is a wearable multifunctional badge (MFB). The MFB 102 has a similar footprint as a conventional badge enabling it to be carried on a lanyard or retractable badge holder. In other examples, the MFB may have a different footprint such as a conventional key fob or key enabling it to be conveniently carried in a purse or pocket. The MFB 102 includes a dynamic display 104 and a natural language interface 106. Natural language or human language input to the MFB 102 cause the MFB 102 to perform some action or operation.

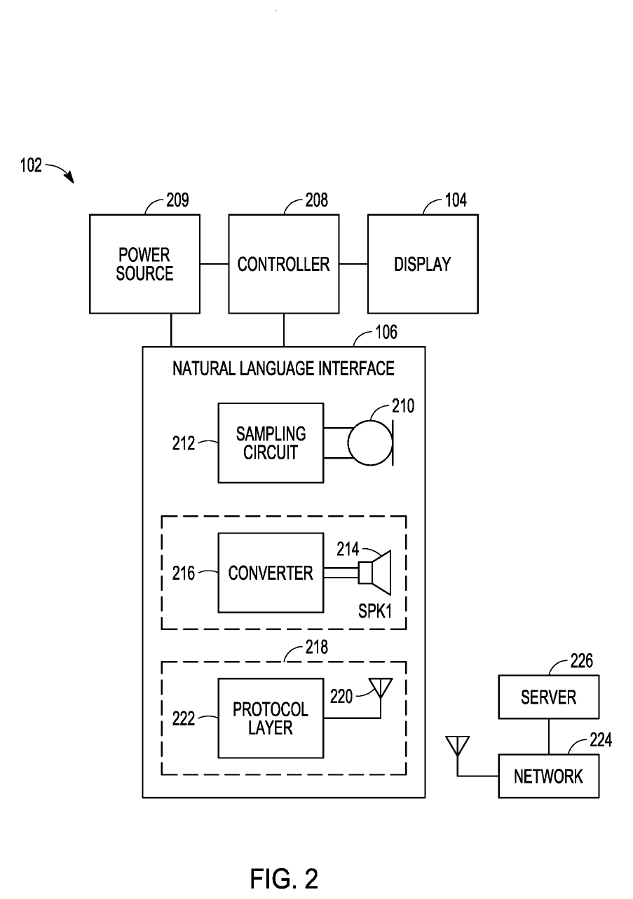

FIG. 2 is a block diagram of portions of an example of an MFB 102. The MFB 102 includes a badge controller 208 operatively coupled to the dynamic display 104 and the natural language interface 106. The badge controller 208 includes a processing device to perform the functions described. The processing device may be a microprocessor, an application specific integrated circuit (ASIC), a field programmable gate array (FPGA), a digital signal processor (DSP), or the like. The dynamic display 104 is a low power display. As an example intended to be non-limiting, the dynamic display 104 is an e-ink display. The dynamic display 104 can be any low power display that can present writing and visual objects in black and white or color with high visibility even in bright ambient lighting. The badge controller 208 can receive natural language input via the natural language interface 106. The natural language interface 106 includes a microphone 210 and a sampling circuit 212 to convert the voice of the wearer into digital signals for processing by the badge controller 208 or another device.

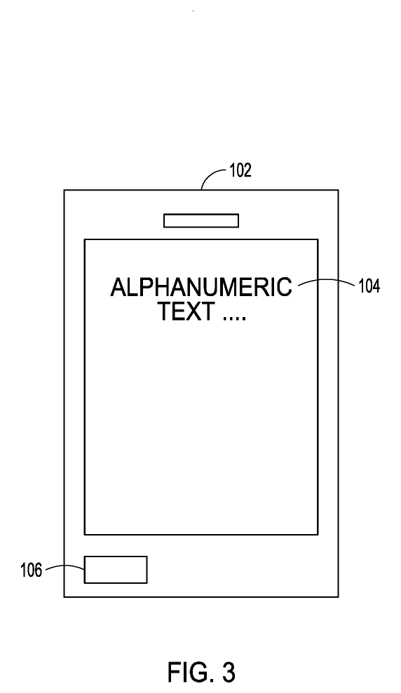

The badge controller 208 can present different information on the dynamic display 104 according to the mode of the MFB 102. In the example of FIG. 1, the MFB 102 is in a display mode that displays an image of the wearer. FIG. 3 shows the MFB 102 in a different display mode that displays alphanumeric text. The badge controller 208 may change the display mode according to the natural language input received using the natural language interface 106. For instance, the wearer of the MFB 102 may say that they want to pass through a controlled door or may ask for a password to pass through the controlled door. The badge controller 208 may change the dynamic display 104 to present a password for entry in response to the stated intent or request of the wearer.

The MFB 102 may include a power source 209 such as a coin battery or a rechargeable power source. The power source 209 may use wired or wireless charging or energy harvesting for recharging the power source 209. In certain examples, the MFB 102 receives power using near field charging such as by an inductive coil. In certain examples, the MFB 102 is powered when it is physically connected to a device with which it is to interact.

The badge controller 208 may output natural language information via natural language interface 106. The natural language interface 106 may include a speaker 214 and a converter 216 to convert digital signals to audio signals for output by the speaker 214. For instance, the wearer of the MFB 102 may say that they want to pass through a controlled door or orally request a password to pass through the controlled door. In response, the MFB 102 may provide a natural language output of the password or other information for the MFB wearer to use to gain access. In a further example, the MFB 102 may both present the password for entry using the dynamic display 104 and provide the password or other information using the natural language interface 106.

The natural language interface 106 may include other means to input and output natural language information. The natural language interface 106 may include a wireless interface 218 that communicates information wirelessly with a separate device. In the example of FIG. 2, the wireless interface 218 includes an antenna 220 and a protocol layer 222 operatively coupled to the antenna 220. The protocol layer 222 can include one or both of a physical (PHY) layer and a medium access control (MAC) layer to implement the wireless protocol (e.g., Bluetooth® Low Energy, or BLE protocol). The badge controller 208 may receive digital signals corresponding to natural language input information from the separate device using the wireless interface and may send digital signals corresponding to natural language output information to the separate device using the wireless interface 218. The separate device may include microphone to receive natural language input of the wearer and a speaker to provide audio to the wearer. For instance, the separate device may include wireless headphones, earphones, or ear buds. The MFB 102 outputs natural language information using the wireless headphones, earphones, or ear buds. In some examples, dynamic display 104 is a touch sensitive display. The badge controller 208 may change the dynamic display to present a keyboard for the badge wearer to input information to the badge controller 208. The badge controller 208 may present the keyboard in response to a natural language request spoken by the wearer to display the keyboard.

The MFB may incorporate an AI agent capable of operating on natural language and other forms of input, performing reasoning based on the input data, interfacing with one or more selected software tools, acting based on the outputs from these tools, and constructing a natural-language output based on all inputs and actions. This output may additionally or alternatively include an image, a sound, or another non-verbal response.

The badge controller 208 may include a language model that produces the natural language output using the natural language input received by the MFB 102. The language model may be a limited or basic model due to the limited processing resources of the MFB 102.

The language model may be based on the Transformer architecture, recurrent architectures such as Long Short-Term Memory (LSTM), or other architectures that enable the deep learning model to effectively operate on relatively long input streams of data. The language model may process text input or operate directly on natural-language audio streams. The natural-language interface 106 may be multimodal model and capable of processing one or more types of input, including text, audio, images, video, and other formats. In some cases, the model may comprise a number of constituent sub-models within a mixture-of-experts (MoE) architecture. Similar to the input handled by the natural-language interface, the output may take multiple forms, including text, audio, imagery, video, and other formats. In the case of text input or output, the MFB system may include a speech-to-text or text-to-speech module, respectively.

The language model may be trained as a generic model capable of understanding natural language broadly. Alternatively, the language model may be adapted to a specific use case through methods such as fine-tuning or de novo training on a specified corpus of training data. In either case, the material used for fine-tuning or de novo training may comprise documents and materials from a particular department, business, company, or industry.

The reasoning performed by the AI agent may take the form of chain-of-thought (CoT) operations, whereby the AI agent produces a set of actions based on the input. These actions may then be executed individually, either sequentially or in parallel where possible. Furthermore, the CoT actions may be modified at one or more stages while the AI agent is executing them, based on partial results from earlier actions.

In some examples, a separate device includes the AI agent that produces the natural language output using the natural language input received by the MFB 102. The wireless interface 218 in FIG. 2 may be a WiFi interface to a WiFi network 224. The badge controller 208 sends the natural language input to the separate device using the WiFi interface and WiFi network. The separate device may be a server 226 that includes a large language model (LLM) to produce the natural language output from the natural language input received from the MFB 102 (e.g., using machine learning (ML) or Artificial Intelligence (AI)). The server 226 sends the natural language output back to the MFB 102 using the WiFi network 224. If a WiFi network is unavailable to provide natural language information, the badge controller 208 may display the unavailability of WiFi or human language capability on the dynamic display 104.

Using an LLM of an AI agent of a server 226 instead of a limited language model on the MFB 102 can allow for more complex communication using the MFB 102. In some examples, the MFB 102 communicates natural language information with the server 226 over the WiFi network 224 to implement Voice Over Internet Protocol (VoIP) calling using the MFB 102. The server 226 may use the LLM to produce a transcript of VoIP call or meetings for later reference. In certain examples, the server 226 sends transcript information to the MFB 102 for display using the dynamic display 104 to facilitate accessibility for badge users with impaired hearing.

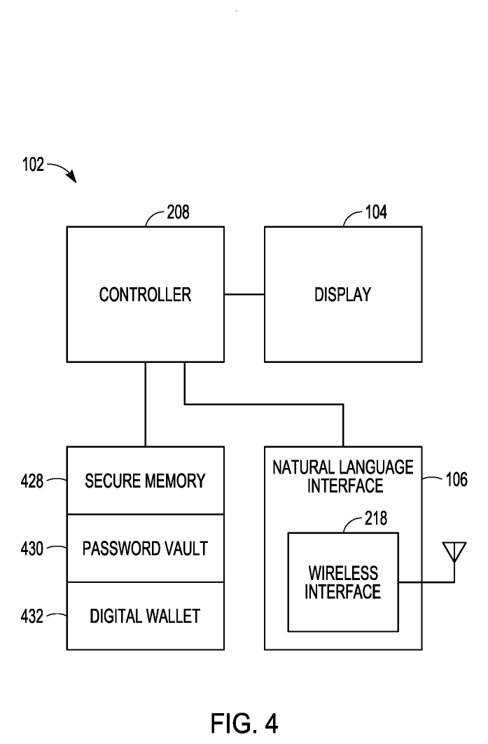

FIG. 4 is a block diagram of portions of another example of an MFB 102. The MFB 102 includes the dynamic display 104, the natural language interface 106, and badge controller 208. The MFB 102 includes secure memory 428 for storing information to prove the holder has the right for access to controlled resources. The secure memory space may be protected with encryption to ensure integrity of the data stored in the secure memory 428 and to protect the stored information.

According to some examples, the secure memory 428 includes a password vault 430 that securely stores passwords. The holder of the MFB 102 can request a password from the password vault. The badge controller 208 may display the password on the dynamic display 104 in response to receiving natural language input that includes the request for the password. In some examples, the badge controller 208 enforces authentication of the holder before providing the requesting password. The badge controller 208 may present a prompt on the dynamic display 104 for authentication information for the request for the password. For instance, the dynamic display 104 can be a touch sensitive dynamic display. The badge controller 208 may present a prompt for the holder to enter a personal identification number (PIN) into the MFB 102 using the touch sensitive dynamic display. The badge controller 208 may present a keypad or number-pad on the touch sensitive dynamic display for the holder to input the PIN. The badge controller 208 authenticates the request for the password using the PIN.

The authentication information may be biometric information. For instance, the badge controller 208 may be able to receive fingerprint information provided by the holder using the touch sensitive dynamic display. In another example, speech recognition of the natural language input received via the natural language interface is matched to speech data for the holder. The speech data may be stored in memory of the MFB 102 and the speech recognition is performed using the badge controller 208. In variations, the natural language input received via the natural language interface is sent to a server 226 for speech recognition. In a further example, the MFB 102 can obtain image data of the holder (e.g., using a camera included in the MFB 102), and the biometric information includes facial recognition of the holder. The badge controller 208 authenticates the request for the password using the biometric information.

According to some examples, the secure memory 428 includes a digital wallet 432 that securely stores digital credentials. The digital credentials can be used to gain access to resources that the holder has rights to access.

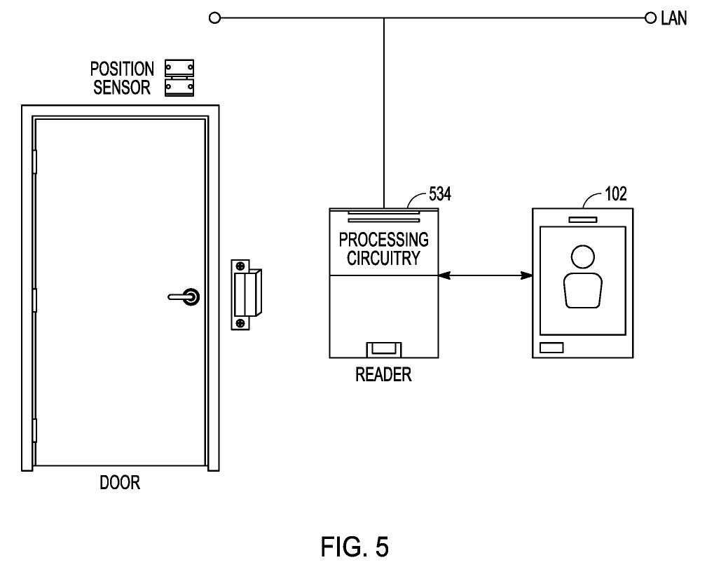

FIG. 5 is an illustration of an example of a basic Physical Access Control System (PACS) structure useful for an office application. The MFB 102 includes a digital wallet that stores digital credentials or data object credentials. The credentials can be provided by the MFB 102 to a verifier device such as a reader device 534 to gain access to secured areas.

The badge controller 208 may send a digital credential in response to receiving natural language input that includes the request for the credential for an identified resource (e.g., access through a controlled doorway). The digital credentials can be provided to another device wirelessly (e.g., using WiFi, Bluetooth®, near field communication (NFC), etc.). The digital credentials can be sent using encryption to the verifier device. In variations, the digital credentials can be provided using a wired interface. For instance, the MFB 102 may include a retractable Universal Serial Bus (USB) connector to connect to the verifier device. The retractable connector enables the MFB 102 to act as a security key (e.g., a Fast IDentity Online (FIDO) security key) or other security implement for other security protocols. Like the passwords, the badge controller 208 may enforce authentication of the holder before providing the digital credentials.

According to some examples, the wireless interface 218 includes an ultra-wide band (UWB) physical layer (UWB PHY) and one or more UWB antennas operatively coupled to the UWB PHI. UWB is a radio communication methodology that uses a wide signal bandwidth. The wide bandwidth is typically defined as either a -10 decibel (dB) bandwidth greater than 20% of the center frequency of the signal, or a bandwidth greater than 500 megahertz (500MHz) in absolute terms. The large bandwidth of UWB systems provides a high level of resilience to frequency selective fading, which is an effect that can limit the performance of narrow-band technologies. The UWB wireless interface is able to transmit and receive UWB ranging information and identification information with a separate device.

The UWB signaling can be used for real time location services (RTLS). The MFB 102 may send identification information (e.g., a specific string or pattern of UWB pulses) using the UWB PHI to devices (e.g., Reader devices) in the vicinity or area where RTLS is provided. The RTLS can be used to track location and movement of people and resources.

In some examples, the UWB signaling can be used to provide point-and-trigger functionality in interaction of the MFB 102 with other devices. The accurate ranging capability of UWB makes it a suitable technology point-and-trigger functionality because the ranging can be used to determine Presence and Intent of the badge holder without a need for actions by the holder.

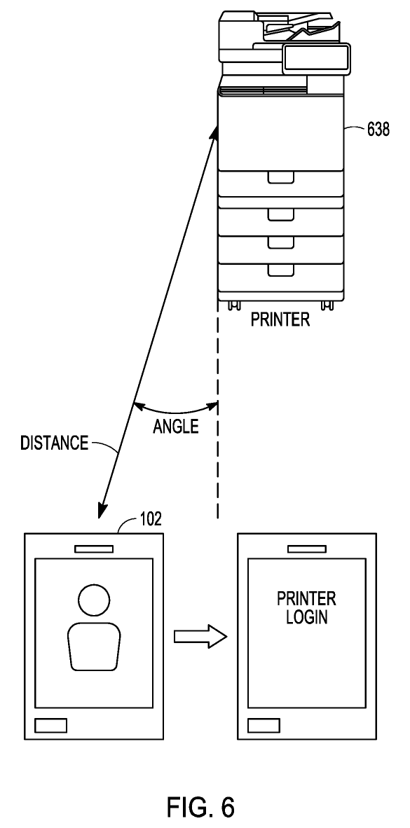

FIG. 6 is an illustration of an example of a UWB capable MFB 102 and a UWB capable device 638 that is a printer. Ranging by the UWB capable MFB 102 can be used to determine Intent of the user. Intent can be deduced by the change in distance between the MFB 102 and UWB capable device 638 and, by the change in angle between the MFB 102 and the UWB capable device 638. Two Way Ranging (TWR) may be used to determine Presence and Intent. In TWR, radio packets are exchanged between the MFB 102, and the UWB capable device 638. The timing differences for the transmitting and receiving of the packets between the MFB 102 and the UWB capable device 638 can be used to calculate ranging information, such as change in one or both of distance and angle, to determine Intent.

The badge controller 208 may change the information presented on the dynamic display 104 according to one or both of the ranging information and device identification information as part of the point-and-trigger functionality. In the example of FIG. 6, the badge controller 208 changes the information of the dynamic display 104 from the image of the badge holder to a prompt on a touch sensitive dynamic display asking for a login to use the printer or to release a secure print job. The information presented on the display depends on the type of device identified by the UWB signaling and by the Presence of the MFB 102 at the device and a determined Intent of the badge holder to use the device.

In some examples, the MFB 102 may contain one or more buttons to initiate specific actions such as duress, alerts for incidents, location notifications, or confirming certain actions. The button activation may send an appropriate message to server or a device (e.g., a reader device) in the vicinity of the MFB 102. The system response to such button activation can be programed to suit the specific use cases such as search and rescue, employee safety, tracking & tracing, etc. The MFB 102 may include one or more sensors to measure the environmental parameters, movement, and heart rate of the wearer that are used in conjunction with other information stored in the device for enabling various applications.

In some examples, the tools accessible to the AI agent may include business systems such as scheduling systems, Customer Relationship Management (CRM) systems, Human Resources Management (HRM) systems, Enterprise Resource Planning (ERP) systems, and others. Additionally, the AI agent may have access to one or more data warehouses or other data repositories. The AI agent may also have access to laptops, workstations, servers, and/or cloud services. The MFB may be able to interface with common business platforms and services such as Microsoft 365®.

In some cases, the AI agent will be able to request input from software tools, such as acting as a meeting assistant and retrieving information about an employee’s next meeting. An example of an interaction with the MFB as Meeting Assistant is below.

Holder: “Hi MFB, what’s the next meeting on my calendar?”

MFB: “Yor next meeting is at 2:00 with Jane Smith and Orval Green in room 222. The topic is ’New snacks for the break room.’”

In other cases, the agent may use one or more software tools to take actions, such as such as requesting the time and location of the wearer’s next meeting, to locate an asset in a facility, to generate and send a brief message to a colleague, and similar tasks. The AI agent may also interact with other AI agents, which in turn may interface with various software tools and services. The AI agent may real time route mapping (aka way finding). The AI agent may be trained to understand the meeting room locations and preferred routes to those meeting rooms. In some examples, the MFB may interface with time-and-attendance systems to enable automated determination of when employees arrive and leave a place of business. In some examples, the MFB might act as an input device for audience polling and feedback for business presentations.

Once all actions associated with a request have been completed, the AI agent may use the language model and/or multimodal model to respond to the user. The response may be in the form of written text, a spoken reply, an image, a video, an audio notification or sound, haptic feedback, and/or a variety of other output formats. The AI agent may be trained to use multiple languages.

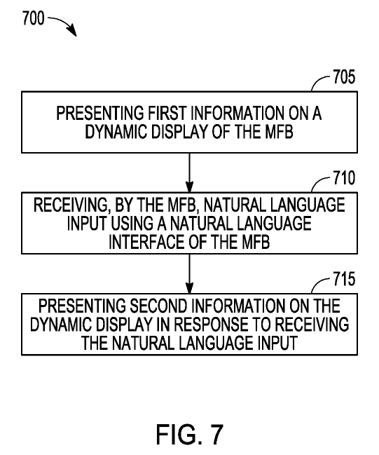

FIG. 7 is a flow diagram of an example of a method 700 of operating a multifunction badge or MFB, such as any of the MFB examples of FIGS. 1-4. The MFB 102 has a dynamic display and information on the dynamic display is changeable by a controller of the MFB 102. The MFB 102 includes a natural language interface to receive natural language input or human language input from the wearer or holder of the badge. The natural language interface can include a microphone to sense the voice of the badge wearer.

At block 705, first information is presented on the dynamic display of the MFB 102. The first information may be default information, such as an image of the person to which the MFB 102 is assigned. At block 710, the MFB 102 receives natural language input using the natural language interface. The natural language input may include a request for information.

At block 715, the MFB 102 presents second information on the dynamic display. The second information may be information requested by the wearer or holder of the MFB 102. The second information may be presented as alphanumeric test or other format, such as a QR code for example. The wearer may have requested a QR code for access to a controlled resource such as a controlled area or to receive a controlled resource, such as items included in an invoice.

The natural language input to the MFB 102 may be processed by a language model of the MFB 102 that can translate the natural language input into one or more actions performed by the MFB 102. In some examples, the one or more actions include the MFB producing a natural language output from the processed natural language input. The natural language output can be produced using a speaker of the natural language interface, or can be transmitted to a separate device for audio (e.g., wireless headphones or ear pods).

The natural language input to the MFB 102 may be sent by the MFB 102 to a second device (e.g., a server) that includes an LLM for processing. The MFB 102 may include a network interface (e.g., a WiFi interface) to send digitized natural language input to the server. The server uses the LLM to translate the natural language input into digitized natural language output that is sent back to the MFB 102. The MFB uses the digitized natural language output to produce audio for the wearer.

Other information may be sent between the server and MFB 102 using the network interface. In some examples, the MFB 102 provides a password vault for the wearer. The wearer may orally state a request that the wearer wants a password to be able to use a specific device, system, or service. In response to the oral request, the MFB 102 may say the password to the wearer, or display the password on the dynamic display. An example of an interaction with the MFB as a password vault is below.

Holder: “Hey MFB, show me my password for logging in to my work laptop.”

MFB: displays password on the dynamic display 106.

Holder: presses ‘ok’ button on dynamic display 106 when finished.

MFB: displays credential text and image.

In variations, the password vault may store passcodes, and the password vault function of the MFB may act as an out-of-band authenticator and not display anything in the interaction with the holder.

In some examples, the MFB 102 is used to store digital credentials. The MFB 102 may receive one or more digital credentials from a server that shows the wearer has certain rights or privileges regarding access to resources. The MFB 102 may present a credential to a third device (e.g., a reader device) for access. The MFB 102 may require the wearer to provide authentication information before the MFB 102 provides a password or a digital credential. In response to a request for a password or credential, the MFB 102 may ask the wearer for the authentication information. The wearer may say the authentication information and the MFB 102 detects the authentication information using the natural language interface. In some examples, the MFB 102 may display a prompt for the wearer to provide authentication information in response to the request for a password or credential. The dynamic display of the MFB may be touch sensitive, and the MFB 102 may display a number-pad or keypad for the wearer to enter the authentication information via the touch sensitive dynamic display.

In some examples, the MFB 102 performs point-and-trigger functions with another device. The MFB 102 may detect presence of another device near the MFB 102 and determine that the MFB wearer intends to interact with the separate device. In response to the determination of presence and intent, the MFB 102 may change the information on the dynamic display to display information useful for interacting with the separate device or display a request for information to use the device (e.g., display a request for a login and a keypad to enter the login).

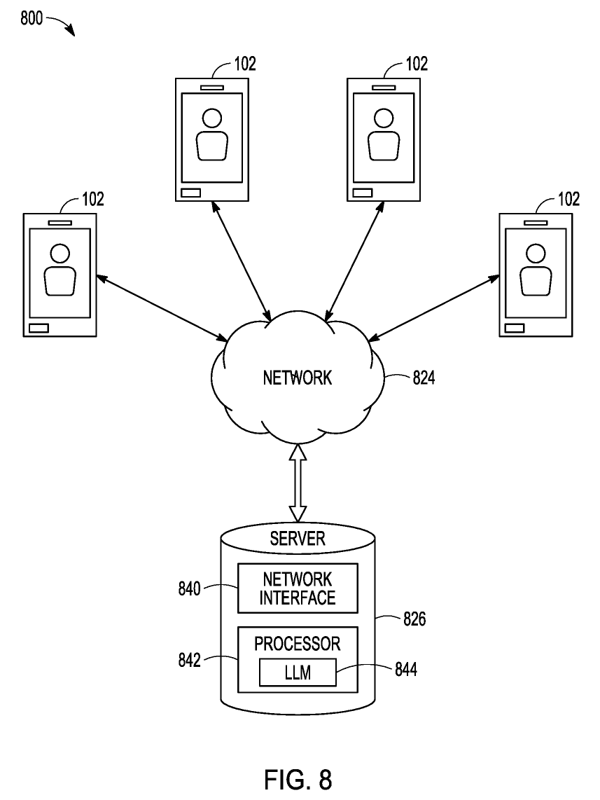

FIG. 8 is an illustration of a system 800 for provisioning information to MFBs. The system 800 includes a server 826 and a network 824. The server 826 includes a network interface 840, processing circuitry 842, and an LLM 844. The system 800 supports services for multiple MFBs 102. The MFBs 102 may be provisioned to employees in a workplace and the server 826 provides services to the MFBs 102. The server 826 may be local to the workplace or remote from the workplace. The MFBs 102 may at any time send digitized natural language information to the server 826 over the network 824 as input. The server 826 translates the natural language information into digitized natural language output and sends the digitized natural language output to the source MFB 102 for audio output.

The server 826 may perform VoIP services between MFBs. The server 826 may receive first digitized natural language information from a first MFB and send the first digitized natural language information to a second MFB that converts the received digitized natural language information into audio for the wearer of the second MFB. The server 826 may send second digitized natural language information from the second MFB 102 back to the first MFB 102 as part of the VoIP conversation.

The server 826 may perform Real Time Location Services (RTLS). The MFBs 102 may interface to one or more devices (e.g., reader device 534 of FIG. 5, UWB capable device 638 of FIG. 6, or network interface device, etc.) for which the server 826 has location information. When an MFB 102 interacts with a device for which the server 826 has location information, the server 826 may store the location information and a timestamp for the registered user of the MFB 102.

The server 826 may include a business software platform and may serve as an interface between the MFBs 102 and the business platform. Providing an interface between the MFBs 102 and the business platform can enable meeting information managed by the platform to be communicated to the MFBs 102 for notification to the wearers.

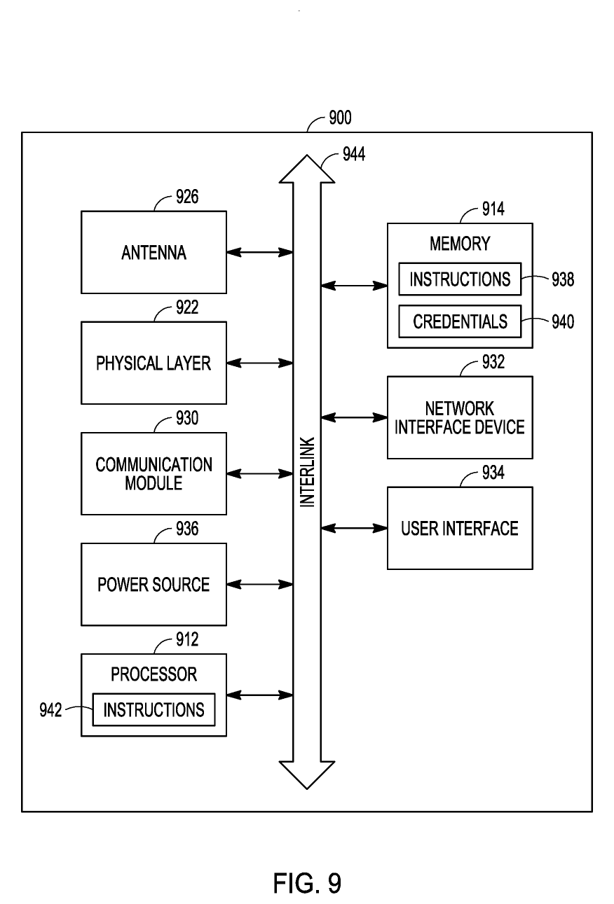

FIG. 9 is a block diagram schematic of various example components for supporting the device architectures described and illustrated herein. At a basic level, the device 900 may be an MFB and can include an interface (e.g., one or more antennas and Integrated Circuit (IC) chip(s)), which permits the device to exchange data with another device, such as a server. With reference specifically to FIG. 9, additional examples of an MFB for supporting the device architecture described and illustrated herein may generally include one or more of a memory 914, processing circuitry such as a processor 912, one or more antennas 926, a communication port or communication module 930, a network interface device 932, a user interface 934, and a power source 936.

Memory 914 can be used in connection with the execution of application programming or instructions by processing circuitry, and for the temporary or long-term storage of program instructions or instruction sets 938. The memory 914 can include credential information 940, such as credential data, credential authorization data, password data, or access control data or instructions, as well as any data, data structures, and/or computer-executable instructions needed or desired to support the above-described device architecture. For example, memory 914 can contain executable instructions that are used by a processor 912 of the processing circuitry to run other components of device 900, and/or to perform any of the functions or operations described herein, such as the example method of FIG. 7 for example. Memory 914 can comprise a device memory that can contain, store, communicate, or transport data, program code, or instructions for use by or in connection with device 900. More specific examples include, but are not limited to, a random access memory (RAM), a read-only memory (ROM), an erasable programmable read-only memory (EPROM or Flash memory), Dynamic RAM (DRAM), any solid-state storage device.

Processor 912 can correspond to one or more computer processing devices or resources. For instance, processor 912 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 912 can be provided as a microprocessor, Central Processing Unit (CPU), or plurality of microprocessors or CPUs that are configured to execute instructions sets 942 stored in an internal processor memory and/or memory 914.

Antenna 926 can correspond to one or multiple antennas and can be configured to provide for wireless communications between device 900 and another device. Antenna(s) 926 can be coupled to one or more physical (PHY) layers 922 to operate using one or more wireless communication protocols and operating frequencies including, but not limited to, the IEEE 802.15.1, Bluetooth, Bluetooth Low Energy (BLE), near field communications (NFC), ZigBee, GSM, CDMA, Wi-Fi, RF, UWB, and the like. In an example, antenna 926 may include one or more antennas coupled to one or more physical layers 922 to operate using UWB for activity, communication, or ranging.

Device 900 may additionally include a communication module 930 and/or network interface device 932. Communication module 930 can be configured to communicate according to any suitable communications protocol with one or more different systems or devices either remote or local to device 900. Network interface device 932 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device 932 can include a plurality of antennas to wirelessly communicate using at least one of single-input multiple-output (SIMO), multiple-input multiple-output (MIMO), or multiple-input single-output (MISO) techniques. In some example embodiments, one or more of the antenna 926, communication module 930, and/or network interface device 932 or subcomponents thereof, may be integrated as a single module or device, function or operate as if they were a single module or device, or may comprise of elements that are shared between them.

User interface 934 can include a dynamic display that may be touch sensitive. Power source 936 can be any suitable internal power source, such as a battery, capacitive power source or similar type of charge-storage device, Device 900 can also include one or more interlinks 944 operable to transmit communications between the various hardware components of the device.

### ADDITIONAL DISCLOSURE AND EXAMPLES

Example 1 includes subject matter (such as a multifunctional badge (MFB)) comprising a dynamic display, a natural language interface, and a badge controller operatively coupled to the dynamic display and natural language interface. The badge controller is configured to change information displayed on the dynamic display, and receive natural language input via the natural language interface and output natural language information via natural language interface.

In Example 2, the subject matter of Example 1 optionally includes a natural language interface including a microphone to receive the natural language input, and a badge controller configured to change information presented on the dynamic display according to the received natural language input.

In Example 3, the subject matter of one or both of claims 1 and 2 optionally includes a natural language interface including a microphone to receive the natural language input, and a speaker to provide natural language output.

In Example 4, the subject matter of one or any combination of Examples 1-3 optionally includes a natural language interface including a wireless interface configured to communicate information wirelessly with a separate device including receiving natural language input information from the separate device and sending the natural language output information to the separate device.

In Example 5, the subject matter of one or any combination of Examples 1-4 optionally includes a badge controller including a language model configured to produce natural language output using the natural language input.

In Example 6, the subject matter of one or any combination of Examples 1-5 optionally includes a natural language interface including a microphone and a WiFi interface to communicate information wirelessly with a separate device, and a badge controller configured to send natural language input information to the separate device using the WiFi interface and receive natural language output information from the separate device using the WiFi interface.

In Example 7, the subject matter of one or any combination of Examples 1-6 optionally includes secure memory to store one or more passwords, and a badge controller configured to display a password on the dynamic display in response to receiving natural language input that includes a request for the password.

In Example 8, the subject matter of Example 7 optionally includes a badge controller configured to present a prompt on the dynamic display for authentication information for the request for the password, receive authentication information for the password, and authenticate the request for the password using the authentication information.

In Example 9, the subject matter of one or any combination of Examples 1-8 optionally includes secure memory to store one or more digital credentials, a wireless interface configured to communicate information wirelessly to a separate device, and a badge controller configured to transmit a credential to the separate device in response to receiving natural language input that includes a request for the credential.

In Example 10, the subject matter of one or any combination of Examples 1-9 optionally includes secure memory to store one or more digital credentials, a wired interface configured to communicate information to a separate device, and a badge controller configured to transmit a credential to the separate device in response to receiving natural language input that includes a request for the credential.

In Example 11, the subject matter of one or any combination of Examples 1-10 optionally includes an ultra-wide band (UWB) physical layer configured to transmit and receive UWB ranging information and identification information with a separate device, and a badge controller configured to change the information presented on the dynamic display according to the ranging information and identification information.

In Example 12, the subject matter of one or any combination of Examples 1-11 optionally includes a dynamic display that is a touch sensitive dynamic display, and a badge controller configured to present a prompt on the touch sensitive display according to identification information of the separate device.

In Example 13, the subject matter of one or any combination of Examples 1-12 optionally includes a rechargeable power source to provide energy to the badge controller, dynamic display, and natural language interface.

Example 14 includes subject matter (such as a method of controlling operation of a multifunction badge (MFB)) or can optionally be combined with one or any combination of Examples 1-13 to include such subject matter, comprising presenting first information on a dynamic display of the MFB; receiving, by the MFB, natural language input using a natural language interface of the MFB; and presenting second information on the dynamic display in response to receiving the natural language input.

In Example 15, the subject matter of Example 14 optionally includes producing, using a language model of the MFB, natural language output information in response to receiving the natural language input; and outputting, using a speaker of the MFB, the natural language output information.

In Example 16, the subject matter of one or both of Examples 14 and 15 optionally includes producing, using a language model of the MFB, natural language output information in response to receiving the natural language input; and transmitting, using a wireless interface of the MFB, natural language output information to a separate device in response to receiving the natural language information.

In Example 17, the subject matter of one or any combination of Examples 14-16 optionally includes transmitting, using a wireless interface of the MFB, received natural language input information to a separate device; receiving, using the wireless interface, natural language output information from the separate device; and outputting, using the natural language interface of the MFB, the natural language output information.

In Example 18, the subject matter of one or any combination of Examples 14-17 optionally includes receiving, using a wireless interface of the MFB, the natural language input from a separate device; producing, using a language model of the MFB, natural language output information in response to receiving the natural language input; and transmitting, using the wireless interface of the MFB, the natural language output information to the separate device.

In Example 19, the subject matter of one or any combination of Examples 14-18 optionally includes receiving a request for a password using the natural language interface of the MFB, and presenting the password on the dynamic display.

In Example 20, the subject matter of Example 19 optionally includes presenting a prompt using a touch sensitive dynamic display of the MFB to enter authentication information for the password, and receiving the authentication information via the touch sensitive dynamic display.

In Example 21, the subject matter of one or any combination of Examples 14-20 optionally includes communicating ultra-wide band (UWB) ranging information and identification information with a separate device, and changing the information presented on the dynamic display according to the ranging information and identification information of the separate device.

In Example 22, the subject matter of Example 21 optionally includes presenting a prompt using a touch sensitive dynamic display of the MFB according to the ranging information and identification information of the separate device.

These non-limiting Examples can be combined in any permutation or combination. The above detailed description includes references to the accompanying drawings, which form a part of the detailed description. The drawings show, by way of illustration, specific embodiments in which the invention can be practiced. The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

What is claimed is:

1. A multifunctional badge (MFB), the MFB comprising:
a dynamic display;
a natural language interface; and
a badge controller operatively coupled to the dynamic display and natural language interface, wherein the badge controller is configured to:
change information displayed on the dynamic display; and
receive natural language input via the natural language interface and output natural language information via natural language interface.

2. The MFB of claim 1, wherein the natural language interface includes:
a microphone to receive the natural language input; and
wherein the badge controller is configured to change information presented on the dynamic display according to the received natural language input.

3. The MFB of claim 1, wherein the natural language interface includes:
a microphone to receive the natural language input; and
a speaker to provide natural language output.

4. The MFB of claim 1, wherein the natural language interface includes
a wireless interface configured to communicate information wirelessly with a separate device including receiving natural language input information from the separate device and sending the natural language output information to the separate device.

5. The MFB of claim 1, wherein the badge controller includes a language model configured to produce natural language output using the natural language input.

6. The MFB of claim 1, wherein the natural language interface includes:
a microphone and a WiFi interface to communicate information wirelessly with a separate device; and
wherein the badge controller is configured to send natural language input information to the separate device using the WiFi interface and receive natural language output information from the separate device using the WiFi interface.

7. The MFB of claim 1, including:
secure memory to store one or more passwords;
wherein the badge controller is configured to display a password on the dynamic display in response to receiving natural language input that includes a request for the password.

8. The MFB of claim 7, wherein the badge controller is configured to:
present a prompt on the dynamic display for authentication information for the request for the password;
receive authentication information for the password; and
authenticate the request for the password using the authentication information.

9. The MFB of claim 1, including:
secure memory to store one or more digital credentials;
a wireless interface configured to communicate information wirelessly to a separate device; and
wherein the badge controller is configured to transmit a credential to the separate device in response to receiving natural language input that includes a request for the credential.

10. The MFB of claim 1, including:
secure memory to store one or more digital credentials;
a wired interface configured to communicate information to a separate device; and
wherein the badge controller is configured to transmit a credential to the separate device in response to receiving natural language input that includes a request for the credential.

11. The MFB of claim 1, including:
an ultra-wide band (UWB) physical layer configured to transmit and receive UWB ranging information and identification information with a separate device; and
wherein the badge controller is configured to change the information presented on the dynamic display according to the ranging information and identification information.

12. The MFB of claim 11,
wherein the dynamic display is a touch sensitive dynamic display; and
wherein the badge controller is configured to present a prompt on the touch sensitive display according to identification information of the separate device.

13. The MFB of claim 1, including a rechargeable power source to provide energy to the badge controller, dynamic display, and natural language interface.

14. A method of controlling operation of a multifunction badge (MFB), the method comprising:
presenting first information on a dynamic display of the MFB;
receiving, by the MFB, natural language input using a natural language interface of the MFB; and
presenting second information on the dynamic display in response to receiving the natural language input.

15. The method of claim 14, including:
producing, using a language model of the MFB, natural language output information in response to receiving the natural language input; and
outputting, using a speaker of the MFB, the natural language output information.

16. The method of claim 14, including:
producing, using a language model of the MFB, natural language output information in response to receiving the natural language input; and
transmitting, using a wireless interface of the MFB, natural language output information to a separate device in response to receiving the natural language information.

17. The method of claim 14, including:
transmitting, using a wireless interface of the MFB, received natural language input information to a separate device;
receiving, using the wireless interface, natural language output information from the separate device; and
outputting, using the natural language interface of the MFB, the natural language output information.

18. The method of claim 14, including:
receiving, using a wireless interface of the MFB, the natural language input from a separate device;
producing, using a language model of the MFB, natural language output information in response to receiving the natural language input; and
transmitting, using the wireless interface of the MFB, the natural language output information to the separate device.

19. The method of claim 14,
wherein the receiving the natural language input includes receiving a request for a password using the natural language interface of the MFB; and
wherein the presenting the second information on the dynamic display includes presenting the password on the dynamic display.

20. The method of claim 19, including:
presenting a prompt using a touch sensitive dynamic display of the MFB to enter authentication information for the password; and
receiving the authentication information via the touch sensitive dynamic display.

21. The method of claim 14, including:
communicating ultra-wide band (UWB) ranging information and identification information with a separate device; and
changing the information presented on the dynamic display according to the ranging information and identification information of the separate device.

22. The method of claim 21, including presenting a prompt using a touch sensitive dynamic display of the MFB according to the ranging information and identification information of the separate device.
